(19) United States
(12) Patent Application Publication
(10) Pub. No.: US 2003/0140296 A1
(43) Pub. Date: Jul. 24, 2003

(54) Method of improving system performance in a wireless network by making requests without acknowledgement

(76) Inventor: Knut T. Odman, Vienna, VA (US)

Correspondence Address: XtremeSpectrum, Inc., Suite 700, 8133 Leesburg Pike, Vienna, VA, 22182, US

(21) Appl. No.: 10/348,011

(22) Filed: Jan. 22, 2003

Related U.S. Application Data
(60) Provisional application No. 60/349,355, filed on Jan. 22, 2002.

(51) Int. Cl. H04L 1/18

(52) U.S. Cl. 714/749

(57) ABSTRACT

A method is provided for processing a request from a remote device to a network coordinator in a wireless network. The remote device sends an association request to the network coordinator, and the network coordinator sends an association response to the remote device without first sending an acknowledgement to the remote device confirming receipt of the association request. In this way the network saves the time and complexity that would have been required creating, sending, and processing acknowledgement signals. Absent an acknowledgement, the remote device waits for up to a timeout period for the association response from the network coordinator, and if it does not come, the association process is a failure. In some implementations, however, the remote device may be allowed to retry sending the request a set number of times before the process fails.

### CROSS-REFERENCE TO RELATED PATENT DOCUMENTS

This application relies for priority on U.S. provisional application serial No. 60/349,355, by Knut T. Odman, filed Jan. 22, 2002, entitled “SYNCHRONOUS REQUESTS WITHOUT ACK TO IMPROVE PERFORMANCE IN SYSTEMS WITH A HARDWARE/SOFTWARE SPLIT,” the contents of which is hereby incorporated by reference in its entirety.

### BACKGROUND OF THE INVENTION

The present invention relates to wireless personal area networks and wireless local area networks. More particularly, the present invention relates to methods of improving the system performance by making system requests without the use of acknowledgement.

The International Standards Organization's (ISO) Open Systems Interconnection (OSI) standard provides a seven-layered hierarchy between an end user and a physical device through which different systems can communicate. Each layer is responsible for different tasks, and the OSI standard specifies the interaction between layers, as well as between devices complying with the standard.

FIG. 1 shows the hierarchy of the seven-layered OSI standard. As seen in FIG. 1, the OSI standard 100 includes a physical layer 110, a data link layer 120, a network layer 130, a transport layer 140, a session layer 150, a presentation layer 160, and an application layer 170.

The physical (PHY) layer 110 conveys the bit stream through the network at the electrical, mechanical, functional, and procedural level. It provides the hardware means of sending and receiving data on a carrier. The data link layer 120 describes the representation of bits on the physical medium and the format of messages on the medium, sending blocks of data (such as frames) with proper synchronization. The networking layer 130 handles the routing and forwarding of the data to proper destinations, maintaining and terminating connections. The transport layer 140 manages the end-to-end control and error checking to ensure complete data transfer. The session layer 150 sets up, coordinates, and terminates conversations, exchanges, and dialogs between the applications at each end. The presentation layer 160 converts incoming and outgoing data from one presentation format to another. The application layer 170 is where communication partners are identified, quality of service is identified, user authentication and privacy are considered, and any constraints on data syntax are identified.

The IEEE 802 Committee has developed a three-layer architecture for local networks that roughly corresponds to the physical layer 110 and the data link layer 120 of the OSI standard 100. FIG. 2 shows the IEEE 802 standard 200.

As shown in FIG. 2, the IEEE 802 standard 200 includes a physical (PHY) layer 210, a media access control (MAC) layer 220, and a logical link control (LLC) layer 225. The PHY layer 210 operates essentially as the PHY layer 110 in the OSI standard 100. The MAC and LLC layers 220 and 225 share the functions of the data link layer 120 in the OSI standard 100. The LLC layer 225 places data into frames that can be communicated at the PHY layer 210; and the MAC layer 220 manages communication over the data link, sending data frames and receiving acknowledgement (ACK) frames. Together the MAC and LLC layers 220 and 225 are responsible for error checking as well as retransmission of frames that are not received and acknowledged.

FIG. 3 is a block diagram of a wireless network 300 that could use the IEEE 802 standard 200. In a preferred embodiment the network 300 is a wireless personal area network (WPAN), or piconet. However, it should be understood that the present invention also applies to other settings where bandwidth is to be shared among several users, such as, for example, wireless local area networks (WLAN), or any other appropriate wireless network.

When the term piconet is used, it refers to a network of devices connected in an ad hoc fashion, having one device act as a coordinator (i.e., it functions as a server) while the other devices (sometimes called stations) follow the time allocation instructions of the coordinator (i.e., they function as clients). The coordinator can be a designated device, or simply one of the devices chosen to function as a coordinator. One primary difference between the coordinator and non-coordinator devices is that the coordinator must be able to communicate with all of the devices in the network, while the various non-coordinator devices need not be able to communicate with all of the other non-coordinator devices.

As shown in FIG. 3, the network 300 includes a coordinator 310 and a plurality of non-coordinator devices 320. The coordinator 310 serves to control the operation of the network 300. As noted above, the system of coordinator 310 and non-coordinator devices 320 may be called a piconet, in which case the coordinator 310 may be referred to as a piconet coordinator (PNC). Each of the non-coordinator devices 320 must be connected to the coordinator 310 via primary wireless links 330, and may also be connected to one or more other non-coordinator devices 320 via secondary wireless links 340, also called peer-to-peer links.

In addition, although FIG. 3 shows bi-directional links between devices, they could also be unidirectional. In this case, each bi-directional link 330, 340 could be shown as two unidirectional links, the first going in one direction and the second going in the opposite direction.

In some embodiments the coordinator 310 may be the same sort of device as any of the non-coordinator devices 320, except with the additional functionality for coordinating the system, and the requirement that it communicate with every device 320 in the network 300. In other embodiments the coordinator 310 may be a separate designated control unit that does not function as one of the devices 320.

Through the course if the following disclosure the coordinator 310 will be considered to be a device just like the non-coordinator devices 320. However, alternate embodiments could use a dedicated coordinator 310. Furthermore, individual non-coordinator devices 320 could include the functional elements of a coordinator 310, but not use them, functioning as non-coordinator devices. This could be the case where any device is a potential coordinator 310, but only one actually serves that function in a given network.

Each device of the network 300 may be a different wireless device, for example, a digital still camera, a digital video camera, a personal data assistant (PDA), a digital music player, or other personal wireless device.

The various non-coordinator devices 320 are confined to a usable physical area 350, which is set based on the extent to which the coordinator 310 can successfully communicate with each of the non-coordinator devices 320. Any non-coordinator device 320 that is able to communicate with the coordinator 310 (and vice versa) is within the usable area 350 of the network 300. As noted, however, it is not necessary for every non-coordinator device 320 in the network 300 to communicate with every other non-coordinator device 320.

FIG. 4 is a block diagram of a device 310, 320 from the network 300 of FIG. 3. As shown in FIG. 4, each device (i.e., each coordinator 310 or non-coordinator device 320) includes a physical (PHY) layer 410, a media access control (MAC) layer 420, a set of upper layers 430, and a management entity 440.

The PHY layer 410 communicates with the rest of the network 300 via a primary or secondary wireless link 330 or 340. It generates and receives data in a transmittable data format and converts it to and from a format usable through the MAC layer 420.

The MAC layer 420 serves as an interface between the data formats required by the PHY layer 410 and those required by the upper layers 430.

The upper layers 430 include the functionality of the device 310, 320. These upper layers 430 may include TCP/IP, TCP, UDP, RTP, IP, LLC, or the like.

The management entity 440 provides monitoring and control functions to the MAC layer 420 and the PHY layer 410, and facilitates communication between the upper layers and the MAC layer 420. The management entity 440 may include a device management entity (DME) for controlling the operation of the device and a MAC layer management entity (MLME) for managing operation of the MAC layer 420. In alternate embodiments the DME can be called a station management entity (SME).

Typically, the coordinator 310 and the non-coordinator devices 320 in a WPAN share the same bandwidth. Accordingly, the coordinator 310 coordinates the sharing of that bandwidth. Standards have been developed to establish protocols for sharing bandwidth in a wireless personal area network (WPAN) setting. For example, the IEEE standard 802.15.3 provides a specification for the PHY layer 410 and the MAC layer 420 in such a setting where bandwidth is shared using a form of time division multiple access (TDMA). Using this standard, the MAC layer 420 defines frames and superframes through which the sharing of the bandwidth by the devices 310, 320 is managed by the coordinator 310 and/or the non-coordinator devices 320.

Device IDs and MAC Addresses

One important aspect of working with devices 310, 320 in a network 300 is uniquely identifying each of the devices 310, 320. There are several ways in which this can be accomplished.

Independent of any network it is in, each device 310, 320 has a unique MAC address that can be used to identify it. This MAC address is generally assigned to the device by the manufacturer such that no two devices 310, 320 have the same MAC address. One set of standards that is used in preferred embodiments of the present invention to govern MAC addresses can be found in IEEE Std. 802-1990, “IEEE Standards for Local and Metropolitan Area Networks: Overview and Architecture.”

For ease of operation, the network 300 can also assign a device ID to each device 310, 320 in the network 300 to use in addition its unique MAC address. In the preferred embodiments the MAC 420 uses ad hoc device IDs to identify devices 310, 320. These device IDs can be used, for example, to route packets within the network 300 based on the ad hoc device ID of the destination of the packet. The device IDs are generally much smaller than the MAC addresses for each device 310, 320. In the preferred embodiments the device IDs are 4-bits and the MAC addresses are 48-bits.

Each device 310, 320 should maintain mapping table that maps the correspondence between device IDs and MAC addresses. The table is filled in based on the device ID and MAC address information provided to the non-coordinator devices 320 by the coordinator 310. This allows each device 310, 320 to reference themselves and the other devices in the network 300 by either device ID or MAC address.

The present invention can be used with the IEEE 803.15.3 standard for high-rate WPANs, which is currently under development by the IEEE 802.15 WPAN™ Task Group 3 (TG3). The details of the current draft 802.15.3 standard, including archives of the 802.15.3 working group can be found at: http://www.ieee802.org/15/pub/TG3.html. Nothing in this disclosure should be considered to be incompatible with the draft 802.15.3 standard, as set forth on the IEEE 802 LAN/MAN Standards Committee web page.

Superframes

The available bandwidth in a given network 300 is split up in time by the coordinator 310 into a series of repeated superframes. These superframes define how the available transmission time is split up among various tasks. Individual frames of data are then transferred within these superframes in accordance with the timing set forth in the superframe.

FIG. 5 is a block diagram of a superframe according to preferred embodiments of the present invention. As shown in FIG. 5, each superframe 500 may include a beacon period 510, a contention access period (CAP) 520, and a contention free period (CFP) 530.

The beacon period 510 is set aside for the coordinator 310 to send a beacon frame out to the non-coordinator devices 320 in the network 300. Such a beacon frame will include information for organizing the operation of devices within the superframe. Each non-coordinator device 320 knows how to recognize a beacon 510 prior to joining the network 300, and uses the beacon 510 both to identify an existing network 300 and to coordinate communication within the network 300.

The CAP 520 is used to transmit commands or asynchronous data across the network. The CAP 520 may be eliminated in many embodiments and the system would then pass commands solely during the CFP 530.

The CFP 530 includes a plurality of time slots 540. These time slots 540 are assigned by the coordinator 310 to a single transmitting device 310, 320 and one or more receiving devices 310, 320 for transmission of information between them. Generally each time slot 540 is assigned to a specific transmitter-receiver pair, though in some cases a single transmitter will transmit to multiple receivers at the same time. Exemplary types of time slots are: management time slots (MTS) and guaranteed time slots (GTS).

An MTS is a time slot that is used for transmitting administrative information between the coordinator 310 and one of the non-coordinator devices 320. As such it must have the coordinator 310 be one member of the transmission pair. An MTS may be further defined as an uplink MTS (UMTS) if the coordinator 310 is the receiving device, or a downlink MTS (DMTS) if the coordinator 310 is the transmitting device.

A GTS is a time slot that is used for transmitting isochronous non-administrative data between devices 310, 320 in the network 300. This can include data transmitted between two non-coordinator devices 320, or non-administrative data transmitted between the coordinator 310 and a non-coordinator device 320.

As used in this application, a stream is a communication between a source device and one or more destination devices. The source and destination devices can be any devices 310, 320 in the network 300. For streams to multiple destinations, the destination devices can be all or some of the devices 310, 320 in the network 300.

In some embodiments the uplink MTS may be positioned at the front of the CFP 530 and the downlink MTS positioned at the end of the CFP 530 to give the coordinator 310 a chance to respond to an uplink MTS in the in the downlink MTS of the same superframe 500. However, it is not required that the coordinator 310 respond to a request in the same superframe 500. The coordinator 310 may instead respond in another downlink MTS assigned to that non-coordinator device 320 in a later superframe 500.

The superframe 500 is a fixed time construct that is repeated in time. The specific duration of the superframe 500 is described in the beacon 510. In fact, the beacon 510 generally includes information regarding how often the beacon 510 is repeated, which effectively corresponds to the duration of the superframe 500. The beacon 510 also contains information regarding the network 300, such as the identity of the transmitter and receiver of each time slot 540, and the identity of the coordinator 310.

The system clock for the network 300 is preferably synchronized through the generation and reception of the beacons 510. Each non-coordinator device 320 will store a synchronization point time upon successful reception of a valid beacon 510, and will then use this synchronization point time to adjust its own timing.

Although not shown in FIG. 5, there are preferably guard times interspersed between time slots 540 in a CFP 530. Guard times are used in TDMA systems to prevent two transmissions from overlapping in time because of inevitable errors in clock accuracies and differences in propagation times based on spatial positions.

In a WPAN, the propagation time will generally be insignificant compared to the clock accuracy. Thus the amount of guard time required is preferably based primarily on the clock accuracy and the duration since the previous synchronization event. Such a synchronizing event will generally occur when a non-coordinator device 320 successfully receives a beacon frame from the coordinator 310.

For simplicity, a single guard time value may be used for the entire superframe. The guard time will preferably be placed at the end of each beacon frame, GTS, ATS, and MTS.

The exact design of a superframe 500 can vary according to implementation. FIG. 6 shows an example of a specific superframe design. As shown in FIG. 6, the transmission scheme 600 involves dividing the available transmission time into a plurality of superframes 610. Each individual superframe 610 includes a beacon frame 620, an uplink MTS 630, a plurality of GTS 640, and a downlink MTS 660. This exemplary superframe includes no contention access period.

The beacon frame 620 indicates by association ID (known as a device ID in the IEEE 802.15.3 draft standard) a non-coordinator device 320 that is assigned to the current superframe 610. It also indicates via a receive-transmit table the transmitter/receiver assignments for the individual GTS 640.

In the exemplary superframe structure shown in FIG. 6, the uplink MTS 630 is set aside for the non-coordinator device 320 assigned to the current superframe 610 to upload signals to the coordinator 310. All other non-coordinator devices 320 remain silent on the current channel during this time slot. In alternate embodiments that use multiple channels, all other stations on that channel must remain silent during an uplink MTS 630, though they may still transmit on alternate channels.

The plurality of GTS 640 are the time slots set aside for each of the devices 310, 320 to allow communication between devices. They do so in accordance with the information set forth in the receive-transmit table in the beacon 620. Each GTS 640 is preferably large enough to transmit one or more data frames. When a transmitter-receiver set is assigned multiple GTS 640, they are preferably contiguous.

The downlink MTS 660 is set aside for the coordinator 310 to download signals to the non-coordinator device 320 assigned to the current superframe 610. All other non-coordinator devices 320 may ignore all transmissions during this time slot.

The lengths of the uplink and downlink MTS 630 and 660 must be chosen to handle the largest possible management frame, an immediate acknowledgement (ACK) frame, and the receiver-transmitter turnaround time. For the GTS 640, the length and number must be chosen to accommodate the specific requirements of frames to be transmitted, e.g., short MPEG frames, large frames of the maximum allowable length, and streaming vs. immediate ACK operation.

Although the disclosed embodiment uses a plurality of GTS 640, one uplink MTS 630 placed before the GTS 640, and one downlink MTS 660 placed after the GTS 640, the number, distribution, and placement of GTS 640 and MTS 630, 660 may be varied in alternate embodiments. Preferred embodiments of the present invention will be described below. And while the embodiments described herein will be in the context of a WPAN (or piconet), it should be understood that the present invention also applies to other settings where bandwidth is to be shared among several users, such as, for example, wireless local area networks (WLAN), or any other appropriate wireless network.

In a wireless network 300, the time it takes to process management data, i.e., the time needed to manage the network 300, directly takes away from time that could be spent sending data, i.e., it limits the data transmit speed. Therefore, it is desirable to reduce the time required to process management data.

The present invention provides a method for reducing the time it takes for the network 300 to process requests from one device to another, e.g., from a non-coordinator device 320 to the coordinator 310.

### SUMMARY OF THE INVENTION

Consistent with the title of this section, only a brief description of selected features of the present invention is now presented. A more complete description of the present invention is the subject of this entire document.

An object of the present invention is to reduce the time it takes for a non-coordinator device to process management data sent from the coordinator, and to reduce the time it takes for a coordinator to process management data sent from the non-coordinator device.

These and other objects are accomplished by way of a method of processing a request from a remote device to a network coordinator in a wireless network, comprising: sending an association request from the remote device to the network coordinator; sending an association response from the network coordinator to the remote device without first sending an acknowledgement to the remote device confirming receipt of the association request.

The step of sending an association request is repeated up to a set number of retry attempts before the step of sending an association response is performed. The set number of retry attempts is preferably between 2 and 16, and most preferably between 4 and 8.

These and other objects are accomplished by way of a method for a remote device request of a network coordinator association into a wireless network, the method comprising: sending an association request from the remote device to the network coordinator; waiting at most a timeout period for a response from the network coordinator to the association request; processing the response if it arrives prior to the timeout period ending; and entering a failure state if the response does not arrive prior to the timeout period ending.

The processing step preferably includes setting a current association identifier for the remote device to an assigned association identifier contained in the response.

The steps of sending and waiting may be repeated for up to a set number of retry attempts before the remote device enters the failure state. The set number of retry attempts is preferably between 2 and 16, and most preferably between 4 and 8.

### BRIEF DESCRIPTION OF THE DRAWINGS

A more complete appreciation of the invention and its many attendant advantages will be readily obtained as it becomes better understood with reference to the following detailed description when considered in connection with the accompanying drawings, in which:

FIG. 1 is a diagram showing the hierarchy of the seven-layered OSI standard;

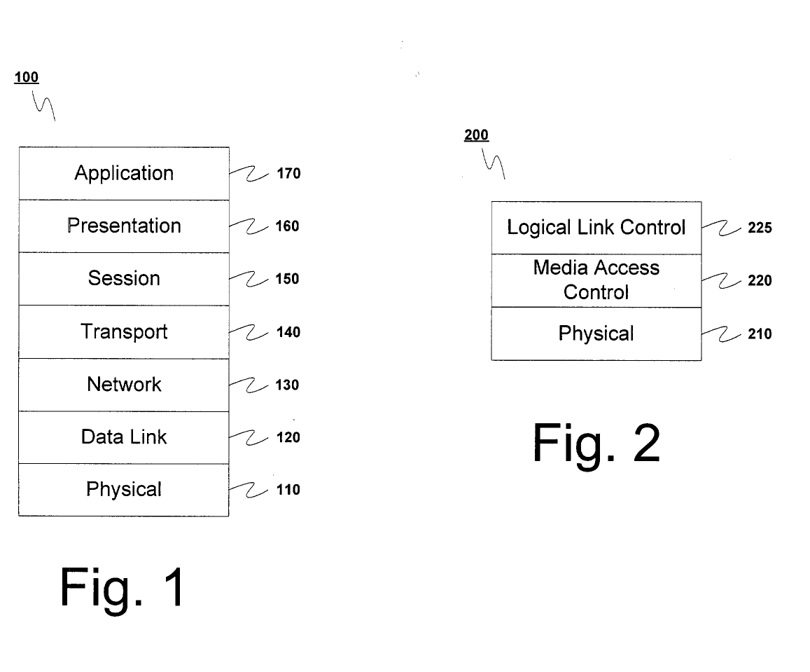

FIG. 2 is a diagram showing the IEEE 802 standard;

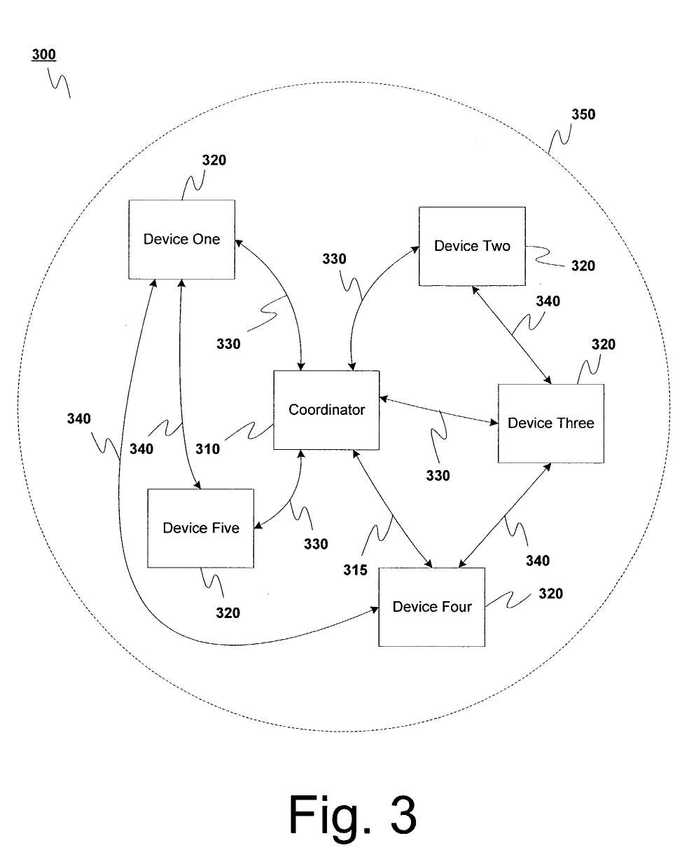

FIG. 3 is a block diagram of a wireless network according to a preferred embodiment of the present invention;

FIG. 4 is a block diagram of a device from the network of FIG. 3;

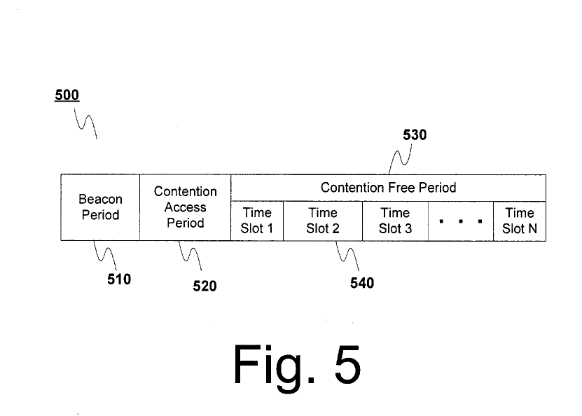

FIG. 5 is a block diagram of a superframe according to preferred embodiments of the present invention;

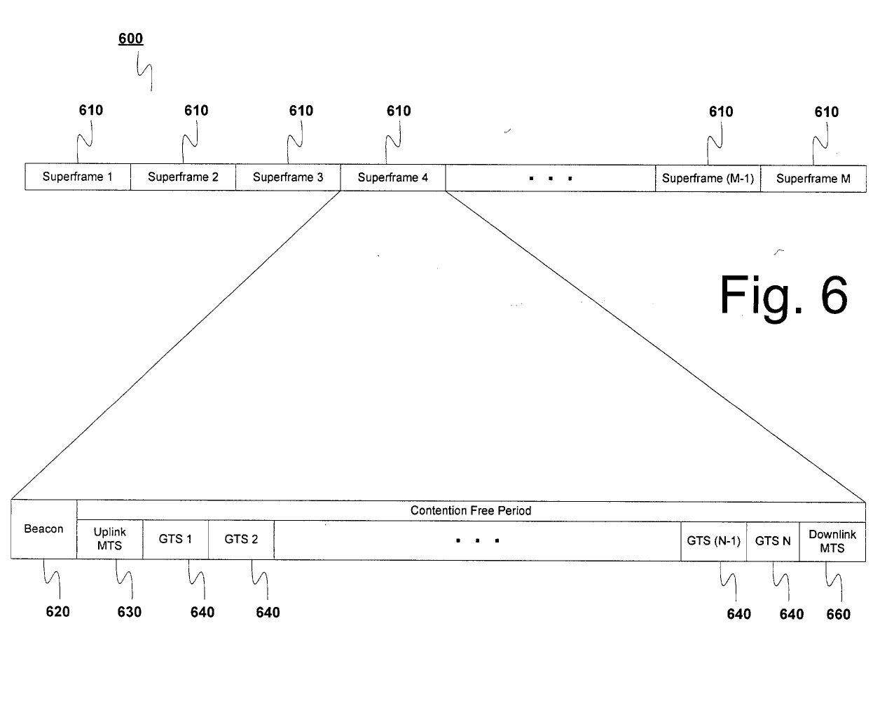

FIG. 6 is a block diagram of a specific superframe design according to a preferred embodiment of the present invention;

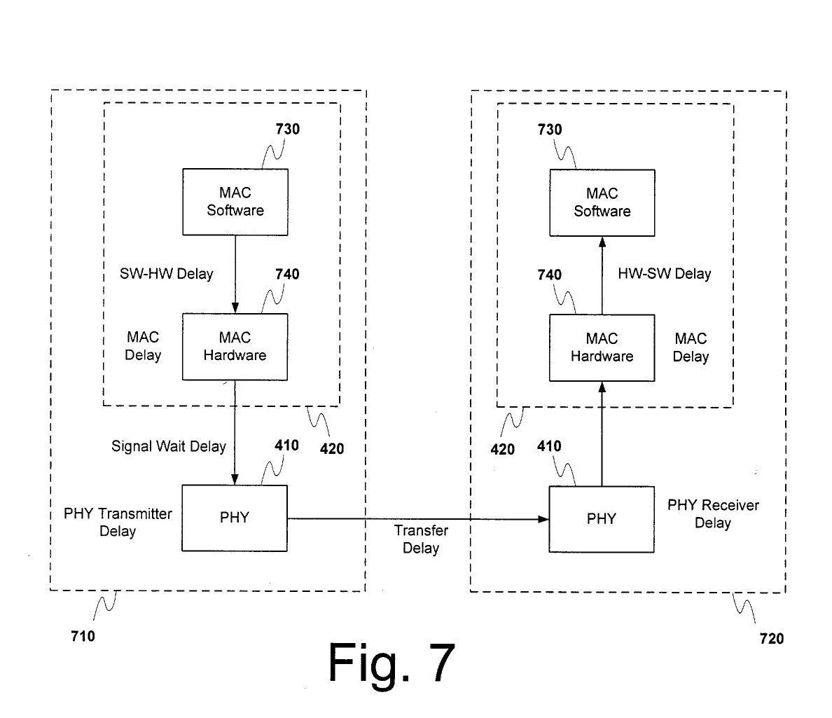

FIG. 7 is a block diagram illustrating exemplary delays in transmission between two devices according to a preferred embodiment of the present invention;

FIG. 8 is a state machine illustrating an association process with acknowledgement according to a preferred embodiment of the present invention;

FIGS. 9A and 9B are flow charts showing the how the delay time for the various paths that an association request might take in the state machine of FIG. 8; and

FIG. 10 is a state machine illustrating an association process without acknowledgement according to a preferred embodiment of the present invention.

### DETAILED DESCRIPTION OF THE PREFERRED EMBODIMENTS

Preferred embodiments of the present invention will now be described with reference to the drawings. Throughout the several views, like reference numerals designate identical or corresponding parts.

Transmission Delays

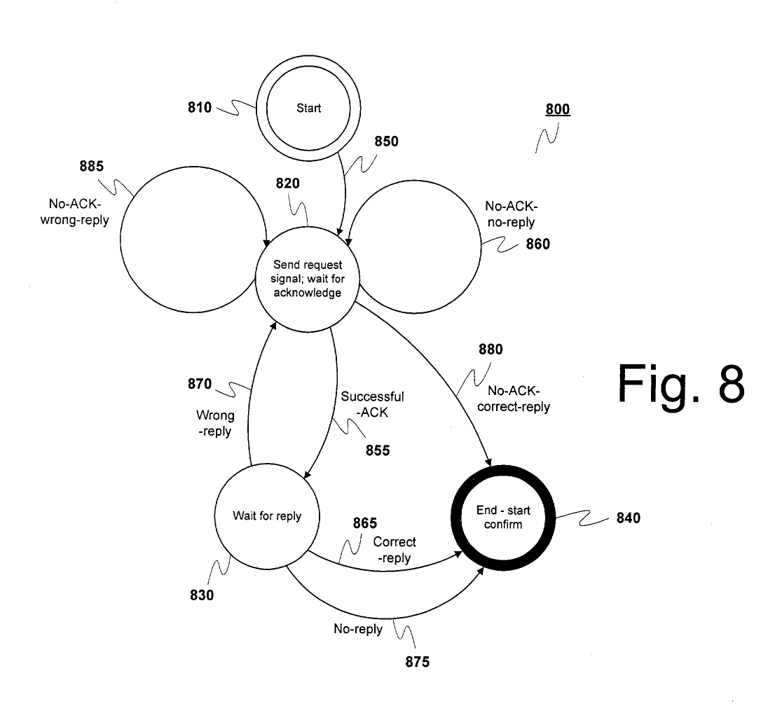

In processing data through a wireless device as described above, numerous delays will occur. FIG. 7 is a block diagram illustrating exemplary delays in transmission between two devices. As shown in FIG. 7, a signal is passed from a transmitter device 710 to a receiver device 720. Although FIG. 7 shows one device as a transmitter and the other as a receiver, either or both of the two devices could be transceivers. However, when any given signal is being transmitted, one device must act as a transmitting device 710 and another as a receiving device 720.

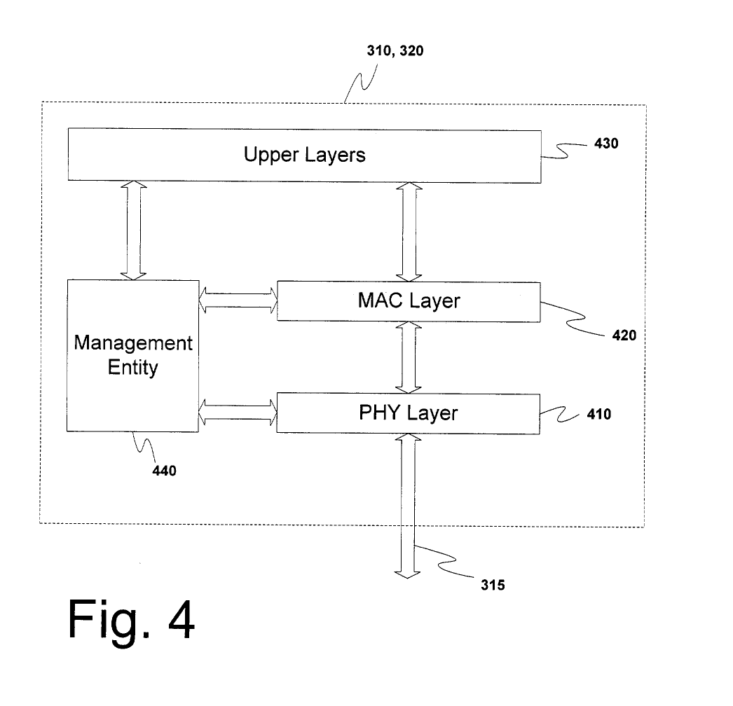

The devices 710 and 720 can be either coordinators 310 or non-coordinating devices 310, as described with respect to FIG. 3. Each device 710, 720 includes a MAC layer 420 and a PHY layer 410. The MAC layers 420 further include MAC software 730 and MAC hardware 740.

A software-to-hardware (SW-HW) delay occurs in the transmitting device 710 as data is transferred from the MAC software 730 to the MAC hardware 740. This SW-HW delay occurs because it takes a certain amount of time from when the MAC software 730 sets a bit in a register to the time that the MAC hardware 740 can “see” the changed bit. This SW-HW delay is significant if the MAC software 730 and MAC hardware 740 operate on significantly different time bases, e.g., a Microsoft Windows driver connected over a PCI to a PCI card with the MAC hardware 740 on it.

A hardware-to-software (HW-SW) delay occurs in the receiving device 720 under similar configurations as the SW-HW delay, and is thus dependent upon the particular hardware and software used in the receiving device 720. The HW-SW delay will be less predictable and generally much bigger since the latencies caused by interrupt handling, context switching, etc. in the operating system must be added.

A MAC hardware (MAC HW) delay can occur in both the transmitting device 710 and the receiving device 720 because it takes a certain amount of time from when the MAC layer 420 receives the last cyclic redundancy check (CRC) bit for a transmission until it can issue an interrupt command (assuming one is called for). This is a fairly constant delay in the MAC hardware 740, but reflects primarily the creation or processing of a frame.

A transmission wait time can occur because the transmitting device 710 needs to wait until the proper time within a transmission scheme to send information. Since the air time in a wireless network is ordered to prevent collisions, the transmitting device 710 may only transmit in an authorized time period.

For example, in an association request according to a preferred embodiment of the present invention, the transmitting device 710 can only transmit an association request during a UMTS that designates an unassigned address, which occurs only once every four superframes. Therefore, if it wants to send an association request, the transmitting device 710 could wait up to four superframes (i.e., four beacon intervals) before it reaches a point in time at which it can send the request.

In alternate embodiments, or for alternate types of requests, the transmission wait time could be different, e.g., the type, periodicity, or number of time slots available for the transmission of requests may be altered. In each case the transmission wait time will depend upon how long the transmitting device 710 has to wait before it can transmit a particular type of request.

A PHY transmitter delay occurs because it takes a certain amount of time from when the PHY layer 410 of the transmitting device 710 gets its first bit until it can be transmitted. The PHY transmitter delay is based solely on the processing time of the PHY layer 410 in the transmitting device 710, and does not include the air time of the transmitted signal.

A PHY receiver delay occurs because it takes a certain amount of time from when the PHY layer 410 of the receiving device 720 receives the transmitted signal until the received signal can be passed on to the MAC hardware 730 for further processing. The PHY receiver delay is based solely on the processing time of the PHY layer 410 in the receiving device 720, and does not include the air time of the transmitted signal.

The PHY transmitter delay and the PHY receiver delay represent delays that are constant regardless of the frame length, transfer rate, distance between devices, or other radio-related delays.

A transfer delay occurs because it takes a certain amount of time for a signal to be transmitted from a transmitting device to a receiving device. This accounts for the air time of the transmitted signal. Some factors that can influence the transfer delay are: the distance between the two devices, the data rate of the transmission, and the length of the signal, obviously.

In addition, a frame separation delay occurs because of the minimal dead air between transmitted frames. This can also be called a shortest inter-frame space (SIFS) delay. The frame separation (or SIFS) delay is necessary to allow the receiving device 720 to properly receive the frames, but serves to delay the final reception of the frames by the receiving device 720.

Also, an acknowledgement timeout delay may occur if a first device 310, 320 requires an acknowledgement for its transmission to a second device, but never receives one. The first device 310, 320 will wait for a set acknowledgement timeout period to receive an ACK frame from the second device 310, 320. If no ACK frame is received within the acknowledgement timeout period, the first device will assume that no ACK frame is arriving. However, it will have suffered the acknowledgement timeout delay to make this determination. The acknowledgement timeout delay can be in the range of 200 μsec.

Similarly, a reply timeout delay may occur if a first device 310, 320 requires a reply to its transmission to a second device, but never receives one. The first device 310, 320 will wait for a set reply timeout period (either after receiving an ACK frame, if acknowledgement is used, or after sending a frame that requires a reply if no acknowledgement is used, or an acknowledgement was sent but not received). If no response frame is received within the reply timeout period, the first device will assume that no response frame is arriving. However, it will have suffered the reply timeout delay to make this determination. The sending device must estimate the worst-case time for a successful request-response sequence to determine when it is time to resend.

Preferably the system design will account for a worst case in each of these delays.

Request with Acknowledgement

Generally an association request is performed with acknowledgement. Under such a scheme, an association request from a device should always be acknowledged by the coordinator 310.

By way of example, the following discussion will examine the operation of a request-response cycle through consideration of an association request. The analysis is similar for other types of requests within a network, and the present invention should not be limited to applying to association requests.

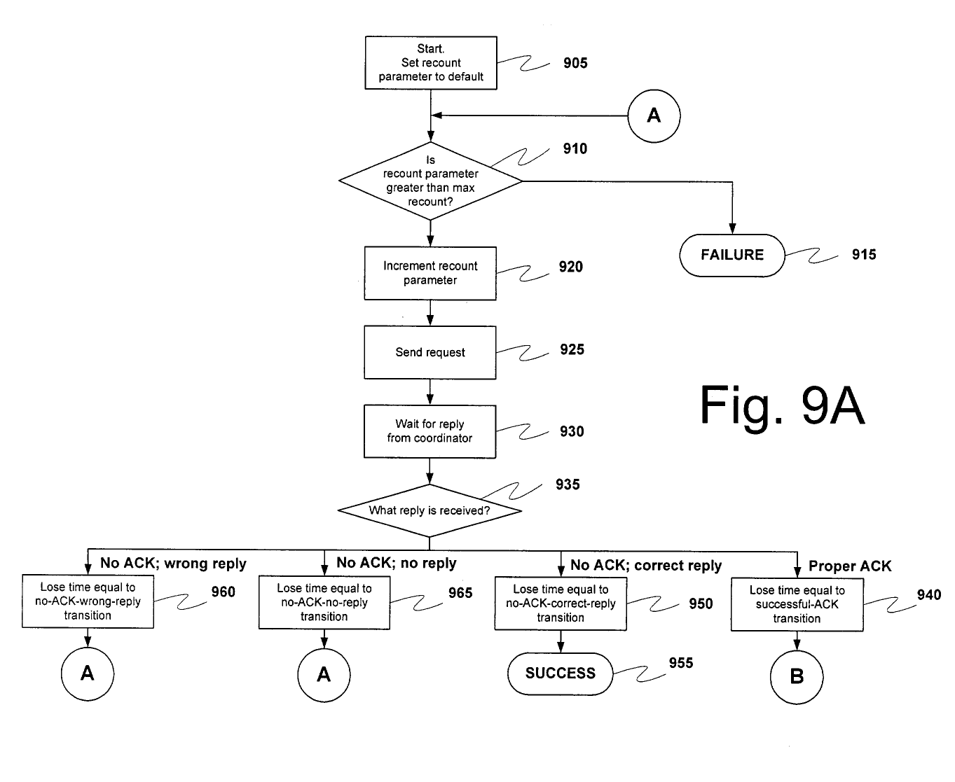

FIG. 8 is a state machine illustrating an association process with acknowledgement. This is the process by which a new device 320 associates itself with an existing network 300, i.e., it tries to make itself a client to the existing coordinator 310. Making the association process “with acknowledgement” means that a request for association from the new device 320 should be acknowledged by the coordinator 310 before a reply to the request is sent to the new device.

As shown in FIG. 8, the state machine 800 includes a start state 810, a first waiting state 820, a second waiting state 830, and an end state 840.

This state machine 800 preferably resides in the software (i.e., the driver). The transition through the state machine represents the roundtrip of a request issued by the software (i.e., client software) until either the software receives a reply or a set time-out period passes with no reply. However, every transition in the state machine 800 has a cost in terms of time, which is calculated in a transition definition.

The start transition 850 occurs when a device management entity (DME) in the management entity 440 of a new device 320 generates a start request signal to the coordinator 310 of an existing network 300. This transitions the state machine 800 from the start state 810 to the first wait state 820. Once it enters the first wait state 820, the new device 320 (through the MAC layer 420 and PHY layer 410 sends a request for association to the coordinator 310 of the network 300 and awaits both acknowledgement (ACK) of that request and an eventual reply from the coordinator 310.

If while in the first wait state 820 the device 320 receives an acknowledgement of its association request, then a successful-ACK transition 855 will occur. This transitions the state machine 800 from the first wait state 820 to the second wait state, where the device 820 waits for a reply to its association request.

If while in the first wait state 820 a set acknowledgement timeout period elapses with no acknowledgement and no reply to the association request, then a no-ACK-no-reply transition 860 occurs. This transitions the state machine 800 from the first wait state 820 back to the first wait state 820, and causes the device to resend the association request and reset the acknowledgement timeout timer.

Once in the second wait state 830, the device 320 can either receive a correct reply to its association request, an incorrect reply to its association request, or no reply at all. If the device receives a correct response frame to its association request, then a correct-reply transition 865 occurs. This transitions the state machine 800 from the second wait state 830 to the end state 840 and indicates a successful stop to the operation of the state machine 800.

If the device 320 receives an incorrect response frame to its association request, e.g., a reply to another device 320, then a wrong-reply transition 870 occurs. This transitions the state machine 800 from the second wait state 830 back to the first wait state 820, which causes the device to resend the association request.

The wrong-reply transition occurs because the association response sent by the coordinator 310 is sent to a group of contending requesters, and the transmitting device 710 was the device that lost the contention. This transition may be invalid for other request-response interactions that are not performed under contention.

If a set reply timeout period passes without the device 320 receiving any reply, then a no-reply transition 875 occurs. This transitions the state machine 800 from the second wait state 830 to the end state 840 and indicates an unsuccessful stop to the operation of the state machine 800.

Two other possibilities can occur, however, if the device 320 receives a response frame while in the first wait state 820, before it has received an acknowledgement of its association request. The result of receiving such an early reply will depend upon whether it is a correct reply or an incorrect reply.

If while in the first wait state 820 the device receives a correct response frame to its association request, then a no-ACK-correct-reply transition 880 occurs. This transitions the state machine 800 from the first wait state 820 to the end state 840 and indicates a successful stop to the operation of the state machine 800. Despite the fact that the device 320 never successfully received an acknowledgement to its association request, it will consider the association request a success. The receipt of the acknowledgement will have been made moot by the receipt of the correct response frame.

If while in the first wait state 820 the device receives an incorrect response frame to its association request, then a no-ACK-wrong-reply transition 885 occurs. This transitions the state machine 800 from the first wait state 820 back to the first wait 820, but does not cause it to resend the request. In this example, the “wrong reply” that was received by the transmitting device 710 indicates to the transmitting device 710 that it lost an association contention. Thus, the transmitting device 710 will try again if it has available retry attempts (up to the retry limit). The renewed request is accounted for in each transition out of the first wait state 820.

The stop state 840 is defined as when a conclusive result of the association operation is reached and a start confirm signal is returned from the coordinator 310 of an existing network 300 to the management entity 440 of the new device 320. The stop state can indicate either a success or a failure situation.

In the case where an unassociated device does not detect a coordinator 310, it will never try an association request.

In the preferred embodiment the retry limit is six, so that the first wait state 820 is terminated after six attempts, Alternate embodiments could use a higher or lower retry limit with an associated bigger or smaller timeout period.

Once the state machine 800 is started with the start transition 850, each of the remaining transitions has an associated delay. These delays can be caused by the new device 320 making the association request, or by the coordinator 310 processing the request.

Successful-ACK Transition

A successful-ACK transition 855 has delays based on the device 320 sending an association request frame to the coordinator 310, the coordinator 310 sending an ACK frame in reply, and the new device 320 receiving the ACK frame.

When the new device 320 (acting as a transmitting device 710) sends the association request frame to the coordinator 310, it causes a SW-HW delay, a MAC HW delay, a transmission wait time, a PHY transmitter delay, and a transfer delay.

When the coordinator 310 receives the association request frame (acting a receiving device 720) and sends the ACK frame in response (acting as a transmitting device 710), it causes a PHY receiver delay, a frame separation delay, a PHY transmitter delay, and a transfer delay. Since the ACK frame is sent in the same time slot as the association request was sent, there is no additional transmission wait time. However, since the coordinator 310 must wait for the minimum time between frames, there is a frame separation delay.

When the new device 320 (acting as a receiving device 720) receives the ACK frame from the coordinator 310, it causes a PHY receiver delay, a MAC HW delay and a HW-SW delay.

No-ACK-No-Reply Transition

A no-ACK-no-reply transition 860 has delays based on the device 320 sending an association request frame to the coordinator 310, the new device 320 waiting for an acknowledgement timeout period and new device 320 processing a timeout command.

When the new device 320 (acting as a transmitting device 710) sends the association request frame to the coordinator 310, it causes a SW-HW delay, a MAC HW delay, a transmission wait time, a PHY transmitter delay, and a transfer delay.

If the device 320 receives no ACK within the acknowledgement timeout period, it suffers an acknowledgement timeout delay and passes an acknowledgement timeout command from its PHY layer 410 to the MAC software 730. The acknowledgement timeout command causes a HW-SW delay. However, since there is no frame to process, there will be no MAC delay.

The acknowledgement timeout delay is preferably equal to the time that it would have taken for the coordinator 310 to provide an ACK frame from the point that the device 320 transmitted the association request. This includes a transfer delay for the association request frame to transfer from the device 320 to the coordinator 310, a PHY receiver delay at the coordinator 310, a PHY transmitter delay as the coordinator 310 sends the ACK frame, a transfer delay for the ACK frame to transfer from the coordinator 310 to the device 320, a frame separation delay, a PHY receiver delay as the device 320 receives the ACK frame, and a MAC HW delay and a HW-SW delay as the device processes the ACK frame.

Since a successful ACK frame would have been sent in the same time slot as the association request was sent, the timeout delay need account for no additional transmission wait time. However, since the coordinator 310 would have had to wait for the minimum time between frames, it must account for a frame separation delay.

Correct-Reply Transition

A correct-reply transition 865 has delays based on the coordinator 310 processing the association request, the coordinator sending a response frame to the new device 320, and the new device 320 processing the response frame.

When the coordinator 310 (acting as a receiving device 720) processes the association request frame from the new device 320, it causes a MAC HW delay and a HW-SW delay.

When the coordinator 310 (acting as a transmitting device 710) sends the response frame to the new device 320, it causes a SW-HW delay, a MAC HW delay, a transmission wait time, a PHY transmitter delay, and a transfer delay.

When the new device 320 (acting as a receiving device 720) receives the response frame from the coordinator 310, it causes a PHY receiver delay, a MAC HW delay, and a HW-SW delay.

Wrong-Reply Transition

A wrong-reply transition 870 has delays based on the coordinator 310 processing the association request, the coordinator sending a response frame to the new device 320, and the new device 320 processing the response frame.

When the coordinator 310 (acting as a receiving device 720) processes the association request frame from the new device 320, it causes a MAC HW delay and a HW-SW delay.

When the coordinator 310 (acting as a transmitting device 710) sends the response frame to the new device 320, it causes a SW-HW delay, MAC delay, a transmission wait time, a PHY transmitter delay, and a transfer delay.

When the new device 320 (acting as a receiving device 720) receives the response frame from the coordinator 310, it causes a PHY receiver delay, a MAC HW delay, and a HW-SW delay. Although it is not a correct reply, the new device 320 must still process the frame before it can discover that it is incorrect.

In addition, although the new device 320 will resend the association request frame to the coordinator 310, the delay for this will be accounted for by the fact that the state machine 800 has returned to the first waiting state 820. A new delay will occur when the state machine 800 exits the first waiting state 820 based on the coordinator's response to the new association request.

No-Reply Transition

A no-reply transition 875 has a delay based on the reply timeout period the new device 320 will wait before it assumes that no reply is forthcoming. After it receives an ACK frame, the new device will cause a reply timeout delay if it is forced to wait for the reply timeout period and ultimately receives no reply.

The reply timeout delay is preferably equal to the length of a superframe (also called a beacon interval, since it's the time between two beacons), multiplied by the number of nodes (i.e., devices 320) in the network 300, multiplied by the number of retry attempts that the coordinator 310 will be granted to send the response frame.

For the sake of simplicity, this allows for no backoff, and assumes that each requesting device gets one chance for an association request per unassigned MTS rotation.

No-ACK-Correct-Reply Transition

A no-ACK-correct-reply transition 880 has delays based on the device 320 sending an association request frame to the coordinator 310, the coordinator 310 receiving the request and sending an ACK frame in reply, the coordinator 310 processing the association request, the coordinator sending a response frame to the new device 320, and the new device 320 processing the response frame.

When the new device 320 (acting as a transmitting device 710) sends the association request frame to the coordinator 310, it causes a SW-HW delay, a MAC HW delay, a transmission wait time, a PHY transmitter delay, and a transfer delay.

When the coordinator 310 (acting as a receiving device 720) processes the association request frame from the new device 320, it causes a PHY receiver delay, a MAC HW delay, and a HW-SW delay.

When the coordinator 310 (acting as a transmitting device 710) sends the response frame to the new device 320, it causes a SW-HW delay, a MAC HW delay, a transmission wait time, a PHY transmitter delay, and a transfer delay.

When the device 320 (acting as a receiving device 720) receives the response frame from the coordinator 310, it causes a PHY receiver delay, a MAC HW delay, and a HW-SW delay.

Although in this transition the coordinator 310 sends an ACK frame to the new device 320, this happens in parallel to the processing of the association request and the preparation and transmission of the response frame. As a result, no time need be accounted for the ACK transmission and reception.

No-ACK-Wrong-Reply Transition

A no-ACK-wrong-reply transition 885 has delays based on the device 320 sending an association request frame to the coordinator 310, the coordinator 310 sending an ACK frame in reply, the coordinator 310 processing the association request, the coordinator sending a response frame to the new device 320, and the new device 320 processing the response frame.

When the new device 320 (acting as a transmitting device 710) sends the association request frame to the coordinator 310, it causes a SW-HW delay, a MAC HW delay, a transmission wait time, a PHY transmitter delay, and a transfer delay.

When the coordinator 310 (acting as a receiving device 720) processes the association request frame from the new device 320, it causes a PHY receiver delay, a MAC HW delay, and a HW-SW delay.

When the coordinator 310 (acting as a transmitting device 710) sends the response frame to the new device 320, it causes a SW-HW delay, a MAC HW delay, a transmission wait time, a PHY transmitter delay, and a transfer delay.

When the new device 320 (acting as a receiving device 720) receives the response frame from the coordinator 310, it causes a PHY receiver delay, a MAC HW delay, and a HW-SW delay. Although it is not a correct reply, the new device 320 must still process the response frame before it can discover that it is incorrect.

Although in this transition the coordinator 310 sends an ACK frame to the new device 320, this happens in parallel to the processing of the association request and the preparation and transmission of the response frame. As a result, no time need be accounted for the ACK transmission and reception.

Time Spent for Request with Acknowledgement

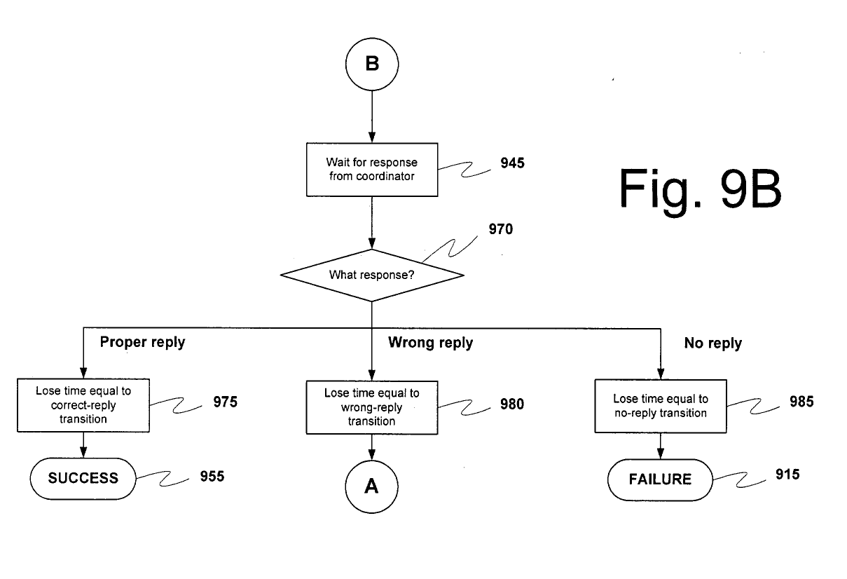

FIGS. 9A and 9B are flow charts showing the how the delay time for the various paths that an association request might take in the state machine of FIG. 8. As shown in FIGS. 9A and 9B, a new device starts an association request by setting the recount parameter to a default number. (Step 905) In the preferred embodiment this is one, though this could vary depending upon what the retry limit is and how it is calculated.

The new device then checks whether the recount parameter is greater than the maximum recount number. (Step 910) Although this will not be the case the first time that the device sends an n association request, the device may return to this step later in the process.

If the recount number has been exceeded, the association operation ends as a failure. (Step 915), If, however, the recount parameter has not been exceeded, the device increments the recount parameter by one (Step 920), sends an association request to the coordinator (Step 925), and waits for a reply from the coordinator. (Step 930)

In Step 930 the new device waits for a reply form the coordinator for a set first timeout period. Although Step 930 indicates that it waits for a response, it actually waits for the first timeout period for either a reply from the coordinator 310 or the end of the first timeout period with no reply (effectively considered a reply of “no reply”).

If the reply is a proper acknowledgement (ACK), then the association process will lose time equal to a successful-ACK transition 855 (Step 940) and will then wait for a response frame from the coordinator 310. (Step 945)

If the reply from the initial request is determined in Step 935 to be no acknowledgement, but instead the correct response frame from the coordinator 310, then the association process will lose time equal to a no-ACK-correct-reply transition 880. (Step 950) and the association operation ends as a success. (Step 955)

If the reply from the initial request is determined in Step 935 to be no acknowledgement, but instead an incorrect response frame from the coordinator 310, then the association process will lose time equal to a no-ACK-wrong-reply transition 885. (Step 960) and will return to Step 910 to determine if another attempt at an association request is allowable.

If the reply from the initial request is determined in Step 935 to be no reply at the end of the first timeout period (as described above), then the association process will lose time equal to a no-ACK-no-reply transition 860 (Step 965), and will return to Step 910 to determine if another attempt at an association request is allowable.

As noted above, in Step 945 the new device will wait for a response frame from the coordinator 310. (Step 945) In a manner similar to Step 930, the new device waits for a response frame from the coordinator for a set second timeout period. Although Step 930 indicates that it waits for a response frame, it actually waits for the second timeout period for either a response from the coordinator 310 or the end of the second timeout period with no response (effectively considered a response of “no response”).

If the new device receives a proper response after receiving an ACK frame in Step 940, then the association process will lose time equal to a correct-reply transition 865 (Step 975), and the association process will end as a success. (Step 955)

If the new device receives a wrong response after receiving an ACK frame in Step 940, then the association process will lose time equal to a wrong-reply transition 870 (Step 980) and will return to Step 910 to determine if another attempt at an association request is allowable.

If no response is received after a successful ACK frame is received in Step 940 by the end of the second timeout period (as described above), then the association process will lose time equal to a no-reply transition 875 (Step 985), and the association process will end as a failure. (Step 915)

Based on the delays listed above, it is possible to determine minimum and maximum wait times for this process by determining the maximum number of times that a device will retry its request if for some reason it fails to get a correct response.

For a preferred embodiment, the inventor used the approximate values for various delays as shown in Table 1.

TABLE 1
Estimated Individual Delays

| Delay | Estimated Value (in μsec) |
|---|---|
| SW-HW delay | 100 |
| MAC HW delay | 1 |
| Transmission wait time | 80000 |
| PHY transmitter delay | 5 |
| PHY receiver delay | 5 |
| Transfer delay | 100 |
| Frame separation delay | 10 |
| HW-SW delay | 50000 |
| Acknowledgement timeout delay | 200 |

For the purposes of this analysis, a retry limit of six was used, and it was assumed that there were four devices 310, 320 in the network 300.

Based on these delays, the inventor determined that each of the transitions shown in FIG. 8 would result in the following delays as shown in Table 2.

TABLE 2
Estimated Transition Delays

| Transition | Total Delay (in μsec) |
|---|---|
| No-ACK-no-reply | 130306 |
| No-ACK-wrong-reply | 260424 |
| Successful-ACK | 130332 |
| Wrong-reply | 180213 |
| Correct-reply | 180213 |
| No-reply | 480000 |
| No-ACK-correct-reply | 260424 |

Thus, the minimum possible delay for an association request with acknowledgement is obtained when no ACK frame is received, but a successful response frame is received on the first request, i.e., 260,424 μs (about 260 ms). The maximum possible delay for an association request with acknowledgement can be calculated to be 2,163,057 μs (about 2.16 sec).

Request without Acknowledgement

In an effort to reduce the total maximum delay, the present inventors have suggested that requests be performed without acknowledgement. Although this will cause delays for possible unnecessary retries, it will save time receiving and processing ACK frames from the coordinator. As above, an association request will be used as an example, although the analysis applies to other requests as well.

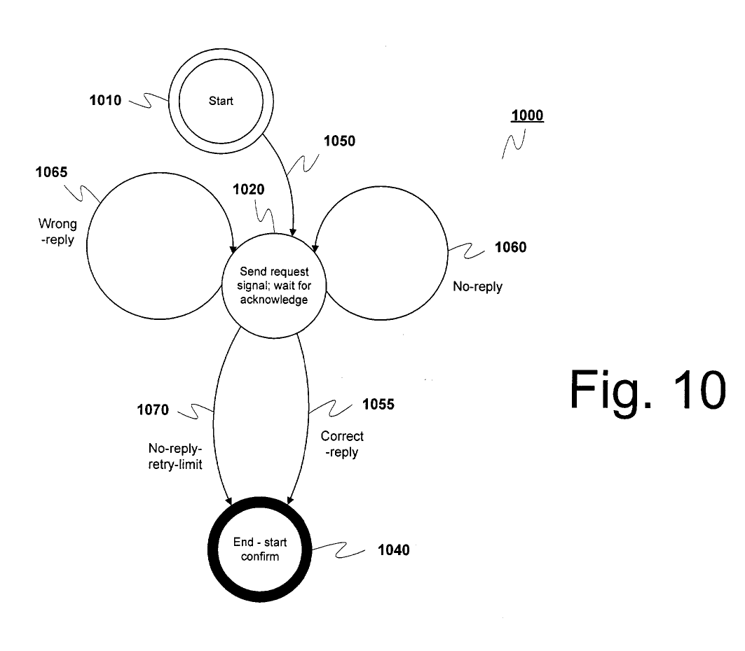

FIG. 10 is a state machine illustrating an association process without acknowledgement. This is the process by which a new device 320 associates itself with an existing network 300, i.e., it tries to make itself a client to the existing coordinator 310. Making the association process “without acknowledgement” means that a request for association from the new device 320 need not be acknowledged by the coordinator 310 before a reply to the request is sent to the new device 320.

As shown in FIG. 10, the state machine 1000 includes a start state 1010, a waiting state 1020, and an end state 1040.

This state machine 1000 preferably resides in software (i.e., the driver). The transition through the state machine represents the roundtrip of a request issued by the software (i.e., client software) until either the software receives a reply or a set time-out period passes with no reply. However, as with the association process with acknowledgement, every transition in the state machine 1000 has a cost in terms of time, which is calculated in a transition definition.

The start transition 1050 occurs when a device management entity (DME) in the management entity 440 of a new device 320 generates a start request signal to the coordinator 310 of an existing network 300. This transitions the state machine 1000 from the start state 1010 to the wait state 1020. Once it enters the wait state 1020, the new device 320 (through the MAC layer 420 and PHY layer 410) sends a request for association to the coordinator 310 of the network 300, resets a retry counter to zero, and awaits an eventual reply from the coordinator 310.

If while in the wait state 1020 the device 320 receives a correct response frame to its association request, then a correct-reply transition 1055 occurs. This transitions the state machine 1000 from the wait state 1020 to the end state 1040 and indicates a successful stop to the operation of the state machine 1000.

If while in the wait state 1020 a set reply timeout period elapses with no reply to the association request being received by the device 320, and without the retry counter exceeding a maximum retry limit, then a no-reply transition 1060 occurs. This transitions the state machine 1000 from the wait state 1020 back to the wait state 1020, causes the device to resend the association request, resets a reply timeout timer, and increments the retry counter.

If while in the wait state 1020 the device 320 receives an incorrect response frame to its association request, e.g., a reply to another device 320, then a wrong-reply transition 1065 occurs. This transitions the state machine 1000 from the wait state 1020 back to the wait state 1020, which causes the device to resend the association request.

If while in the wait state 1020 the reply timeout period elapses with no reply to the association request being received by the device 320, but the retry counter exceeds the maximum retry limit, then a no-reply-retry-limit transition 1070 occurs. This transitions the state machine 1000 from the wait state 1020 to the end state 1040 and indicates an unsuccessful stop to the operation of the state machine 1000.

Once the state machine 1000 is started with the start transition 1050, each of the remaining transitions has an associated delay. These delays can be caused by the new device 320 making the association request, or by the coordinator 310 processing the request.

Correct-Reply Transition

A correct-reply transition 1055 has delays based on the device 320 sending an association request frame to the coordinator 310, the coordinator 310 processing the association request, the coordinator sending a response frame to the new device 320, and the new device 320 processing the response frame.

When the new device 320 (acting as a transmitting device 710) sends the association request frame to the coordinator 310, it causes a SW-HW delay, a MAC HW delay, a transmission wait time, a PHY transmitter delay, and a transfer delay.

When the coordinator 310 (acting as a receiving device 720) processes the association request frame from the new device 320, it causes a PHY receiver delay, a MAC HW delay, and a HW-SW delay.

When the coordinator 310 (acting as a transmitting device 710) sends the response frame to the new device 320, it causes a SW-HW delay, a MAC HW delay, a transmission wait time, a PHY transmitter delay, and a transfer delay.

When the new device 320 (acting as a receiving device 720) receives the response frame from the coordinator 310, it causes a PHY receiver delay, a MAC HW delay, and a HW-SW delay.

If during this transition the coordinator 310 sends an ACK frame to the new device 320, this would happen in parallel to the processing of the association request and the preparation and transmission of the response frame. As a result, even if acknowledgement was required, no time need be accounted for any ACK transmission and reception.

No-Reply Transition

A no-reply transition 1060 has delays based on the device 320 sending an association request frame to the coordinator 310, and the new device 320 waiting for a reply timeout period.

When the new device 320 (acting as a transmitting device 710) sends the association request frame to the coordinator 310, it causes a SW-HW delay, MAC delay, a transmission wait time, a PHY transmitter delay, and a transfer delay.

Since the no-reply transition occurs when the reply timeout period elapses with no reply to the association request being received by the device 320 (and without the retry counter exceeding a maximum retry limit), the new device 320 suffers a timeout delay.

This timeout delay must be the same as what the worst-case successful reception would have been. In other words, it must account for the coordinator 310 (acting as a receiving device 720) processing the association request frame from the new device 320 (causing a PHY receiver delay, a MAC HW delay, and a HW-SW delay), the coordinator 310 (acting as a transmitting device 710) sending the response frame to the new device 320 (causing a SW-HW delay, a MAC HW delay, a transmission wait time, a PHY transmitter delay, and a transfer delay), and the new device 320 (acting as a receiving device 720) receiving the response frame from the coordinator 310 (causing a PHY receiver delay, a MAC HW delay, and a HW-SW delay).

Once the requesting device 320 has heard nothing within this worst-case time, it knows that it is safe to try again. In addition, although the new device 320 will resend the association request frame to the coordinator 310, the delay for this will be accounted for by the fact that the state machine 1000 has returned to the waiting state 1020. A new delay will occur when the state machine 1000 exits the waiting state 1020 based on the coordinator's response to the new association request.

Wrong-Reply Transition

A wrong-reply transition 1065 has delays based on the device 320 sending an association request frame to the coordinator 310, the coordinator 310 processing the association request, the coordinator sending a response frame, and the new device 320 processing the response frame. This is similar to a correct-reply transition 1055, except that the response frame is intended for another device.

When the new device 320 (acting as a transmitting device 710) sends the association request frame to the coordinator 310, it causes a SW-HW delay, a MAC HW delay, a transmission wait time, a PHY transmitter delay, and a transfer delay.

The coordinator 310 (acting as a receiving device 720) then processes an association request frame from a competing device, causing a PHY receiver delay, a MAC HW delay, and a HW-SW delay. This is done following a contention between the requesting device 320 and a competing device (in which the competing device won) and so occurs after the request frame from the requesting device.

When the coordinator 310 (acting as a transmitting device 710) sends the response frame to the competing device, it causes a SW-HW delay, a MAC HW delay, a transmission wait time, a PHY transmitter delay, and a transfer delay.

When the new device 320 (acting as a receiving device 720) receives the response frame from the coordinator 310, it causes a PHY receiver delay, a MAC HW delay and a HW-SW delay. Despite the fact that this is an incorrect response frame for the requesting device 320, it still has to process the response frame to discover this.

If during this transition the coordinator 310 sends an ACK frame to the new device 320, this would happen in parallel to the processing of the association request and the preparation and transmission of the response frame. As a result, even if acknowledgement was required, no time need be accounted for any ACK transmission and reception.

No-Reply-Retry-Limit Transition

A no-reply-retry-limit transition 1070 occurs when the requesting device 320 has reached its final number of retries and cannot send another request. As a result, this simply transitions the requesting device 320 to an end state 1040 as a failure without any delay.

Time Spent for Request without Acknowledgement

Based on the delays listed above, it is possible to determine minimum and maximum wait times for this process by determining the maximum number of times that a device will retry its request if for some reason it fails to get a correct response.

For a preferred embodiment, the inventor used the approximate values for various delays as shown in Table 3.

TABLE 3
Estimated Individual Delays

| Delay | Estimated Value (in μsec) |
|---|---|
| SW-HW delay | 100 |
| MAC HW delay | 1 |
| Transmission wait time | 80000 |
| PHY transmitter delay | 5 |
| PHY receiver delay | 5 |
| Transfer delay | 100 |
| Frame separation delay | 10 |
| HW-SW delay | 50000 |
| Acknowledgement timeout delay | 200 |

For the purposes of this analysis, a retry limit of six was used, and it was assumed that there were four devices 310, 320 in the network 300.

Based on these delays, the inventor determined that each of the transitions shown in FIG. 8 would result in the following delays, as shown in Table 4.

TABLE 4
Estimated Transition Delays

| Transition | Total Delay (in μsec) |
|---|---|
| No-reply | 260424 |
| Wrong-reply | 260424 |
| No-reply-retry-limit | 0 |
| Correct-reply | 260424 |

Since the total delay for each transition except the no-reply-retry-limit transition 1070 is the same, it is easy to calculate the minimum and maximum possible delays for an association request without acknowledgement. The minimum delay is a single pass through, which causes a single delay, i.e., 260,424 μs (about 260 ms). With a retry limit of six, the maximum delay is six times the minimum delay, i.e., 1,562,544 μs (about 1.56 sec).

Based on the above calculations, it's clear that the worst-case delay in an association process with acknowledgement is greater than the than a worst-case delay in an association process without acknowledgement. (2.16 seconds versus 1.56 seconds). As a result, these calculations show that although time will be lost because of miscommunications between devices that could be avoided by acknowledgement, that increased delay is more than made up for by the saved time in eliminating acknowledgements.

Therefore, according to this preferred embodiment of the present invention, acknowledgement frames can be eliminated in some or all operations, even operations in which acknowledgement was previously required.

Furthermore, an additional advantage is obtained if acknowledgements are eliminated altogether in management time frames. In such a case, the network can reduce the total size of the MTS. Since there will be no acknowledgements, there is no need to allocate time in an MTS for one. This can shorten the size of the superframe and thereby marginally increase the data transmission rate.

Obviously, numerous modifications and variations of the present invention are possible in light of the above teachings. For example, alternate requests could be used aside from an association request. Any request not using contention would be simpler, since it would eliminate the possibility of receiving a wrong response. However, the analysis would be similar.

It is therefore to be understood that within the scope of the appended claims, the invention may be practiced otherwise than as specifically described herein.

We claim:

1. A method of processing a request from a remote device to a network coordinator in a wireless network, comprising:
sending an association request from the remote device to the network coordinator;
sending an association response from the network coordinator to the remote device without first sending an acknowledgement to the remote device confirming receipt of the association request.

2. A method of processing a request from a remote device to a network coordinator in a wireless network, as recited in claim 1, wherein the step of sending an association request is repeated up to a set number of retry attempts before the step of sending an association response is performed.

3. A method of processing a request from a remote device to a network coordinator in a wireless network, as recited in claim 2, wherein the set number of retry attempts is between 2 and 16.

4. A method of processing a request from a remote device to a network coordinator in a wireless network, as recited in claim 3, wherein the set number of retry attempts is between 4 and 8.

5. A method for a remote device request of a network coordinator association into a wireless network, the method comprising:
sending an association request from the remote device to the network coordinator;
waiting at most a timeout period for a response from the network coordinator to the association request;
processing the response if it arrives prior to the timeout period ending; and
entering a failure state if the response does not arrive prior to the timeout period ending.

6. A method of processing a request from a remote device to a network coordinator in a wireless network, as recited in claim 5, wherein the processing step includes setting a current association identifier for the remote device to an assigned association identifier contained in the response.

7. A method of processing a request from a remote device to a network coordinator in a wireless network, as recited in claim 5, wherein the steps of sending and waiting are repeated for up to a set number of retry attempts before the remote device enters the failure state.

8. A method of processing a request from a remote device to a network coordinator in a wireless network, as recited in claim 7, wherein the set number of retry attempts is between 2 and 16.

9. A method of processing a request from a remote device to a network coordinator in a wireless network, as recited in claim 8, wherein the set number of retry attempts is between 4 and 8.
